(19) United States
(12) Patent Application Publication
(10) Pub. No.: US 2009/0205255 A1
(43) Pub. Date: Aug. 20, 2009

(54) Security gate with emergency escape

(76) Inventor: Victor G. Shelton, Ontario (CA)

Correspondence Address: WELSH & FLAXMAN LLC, 2000 DUKE STREET, SUITE 100, ALEXANDRIA, VA, 22314, US

(21) Appl. No.: 12/068,993

(22) Filed: Feb. 14, 2008

(51) Int. Cl. E06B 3/68; E05D 11/10

(52) U.S. Cl. 49/56; 16/319

(57) ABSTRACT

An exterior security gate for preventing passage through a passageway includes a grate structure shaped and dimensioned to fit over and cover the passageway. The grate structure includes a first side frame member and a second side frame member. A first hinge is secured to the first side frame member for pivotally mounting the grate structure to an exterior wall of a building structure. A chain with a plurality of apertures is secured to and extends from the second side frame member. The chain is of a length sufficient to pass through a bore formed in the building structure in the area proximate to the passageway with the grate structure positioned over the passageway. A tamper shield bracket is secured along an interior wall of the building structure in alignment with the bore. The tamper shield bracket includes a locking pin selectively positioned within an aperture of the chain to securely lock the grate structure in a closed orientation.

### BACKGROUND OF THE INVENTION

1. Field of the Invention

The invention relates to a security gate. More particularly, the invention relates to both an internal security gate and an external security gate for positioning adjacent a window for permitting selective opening and closing thereof during an emergency without detracting from the gate's ability to prevent undesired passage through the window or other building opening.

2. Description of the Related Art

A variety of security gates are known for preventing access to windows and other passageways, which without the use of the security gate would provide for a convenient entrance point for those wishing to illegally enter a building. While these security gates are designed to prevent undesired access through the window, circumstances do arise where it is necessary for the building owner or occupant to open the security gate to allow passage through the window or other passageway.

Security gates have been designed for permitting selective opening and closing thereof. However, there is always a balance between the security provided when the security gate is closed and the need to provide for unlocking when it is desired to provide access through the window or other passageway. The present invention provides a security gate offering a high level of security in combination with convenient unlocking when passage thetethrough is desired.

### SUMMARY OF THE INVENTION

It is, therefore, an object of the present invention to provide a security gate for occupants of a building providing a safe means of escape for the occupants in the event of an emergency.

As such, it is an object of the present invention to provide an exterior security gate for preventing passage through a passageway. The security gate includes a grate structure shaped and dimensioned to fit over and cover the passageway. The grate structure includes a first side frame member and a second side frame member. A first hinge assembly is secured to the first side frame member for pivotally mounting the grate structure to an exterior wall of a building structure. A chain with a plurality of apertures is secured to and extends from the second side frame member. The chain is of a length sufficient to pass through a bore formed in the building structure in the area proximate to the passageway with the grate structure positioned over the passageway. A tamper shield bracket is secured along an interior wall of the building structure in alignment with the bore. The tamper shield bracket includes a locking pin selectively positioned within an aperture of the chain to securely lock the grate structure in a closed orientation.

It is also an object of the present invention to provide an exterior security gate wherein the tamper shield bracket includes an aperture aligned with the aperture passing through the wall of the building structure for passage of the chain therethrough.

It is another object of the present invention to provide an exterior security gate wherein the tamper shield bracket includes a tamper protection flange extending from an edge at a 90° angle along the side of the tamper shield bracket closest to the passageway.

It is a further object of the present invention to provide an exterior security gate wherein the tamper shield bracket includes a compression sleeve securely mounting it upon the wall of the building structure.

It is also an object of the present invention to provide an exterior security gate wherein the aperture of the tamper shield bracket through which the locking pin passes is formed in the compression sleeve.

It is another object of the present invention to provide an exterior security gate wherein the grate structure includes a grate assembly including a plurality of bars that are spaced no more than 1.5 inches from each other.

It is still another object of the present invention to provide an exterior security gate wherein the first hinge assembly includes a first pipe sleeve including a central aperture shaped and dimensioned to receive a first hinge bolt secured to the exterior wall of the building structure.

It is yet another object of the present invention to provide an exterior security gate wherein the first hinge bolt is substantially L-shaped and includes a first leg shaped and dimensioned for positioning within the first pipe sleeve and a second leg shaped and dimensioned for passage through the wall of the building structure for securely mounting the first hinge bolt, and ultimately the entire security gate, thereto.

It is a further object of the present invention to provide an exterior security gate wherein a nut is secured to a threaded free end of the second leg of the first hinge bolt for securing the first hinge bolt in position along the wall.

It is also an object of the present invention to provide an exterior security gate including a second hinge assembly, the second hinge assembly includes a second pipe sleeve including a central aperture shaped and dimensioned to receive a second hinge bolt secured to the exterior wall of the building structure.

It is still a further object of the present invention to provide an exterior security gate wherein the second hinge bolt is substantially L-shaped and includes a first leg shaped and dimensioned for positioning within the second pipe sleeve and a second leg shaped and dimensioned for passage through the wall of the building structure for securely mounting the second hinge bolt, and ultimately the entire security gate, thereto.

It is also an object of the present invention to provide an exterior security gate wherein a nut is secured to a threaded free end of the second leg of the second hinge bolt for securing the first hinge bolt in position along the wall.

It is another object of the present invention to provide an exterior security gate wherein the second side frame member includes a plate which couples the chain to the second side frame member.

It is a further object of the present invention to provide an exterior security gate wherein the bore passing through the building structure is a metal sleeve lined bore.

It is also an object of the present invention to provide an interior security gate for preventing passage through a passageway. The gate includes a grate structure shaped and dimensioned to fit over and cover the passageway. The grate structure includes a first side frame member and a second side frame member. A first hinge assembly is secured to the first side frame member for pivotally mounting the grate structure to an interior wall of a building structure. A locking assembly is secured along an interior wall surface of the building structure for selective engagement with the second side frame member to control opening and closing of the grate structure. The locking assembly includes a locking hinge composed of a first locking hinge member and a second locking hinge member shaped and dimensioned to wrap around the second side frame member to selectively prevent movement of the grate structure.

It is another object of the present invention to provide an interior security gate wherein the first locking hinge member is substantially U-shaped and includes a first leg and a second leg with a connecting plate member extending therebetween.

It is a further object of the present invention to provide an interior security gate where the first locking hinge member and the second locking hinge member define a cavity into which the second side frame member is positioned for locking the grate structure in a closed orientation.

It is still a further object of the present invention to provide an interior security gate wherein a locking pin maintains the second locking hinge member in position.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a perspective view of a security gate for exterior installation in accordance with the present invention.

FIG. 2 is a cross sectional view of the security gate shown in FIG. 1 along the line 2-2.

FIG. 3 is a cross sectional view of the first hinge assembly of the security gate shown with reference to FIG. 1.

FIG. 4 is a cross sectional view of the second hinge assembly of the security gate shown with reference to FIG. 1.

FIG. 5 is a front plan view showing the tamper shield bracket and associated structure along the interior wall as utilized in conjunction with the security gate shown with reference to FIG. 1.

FIG. 6 is a cross sectional view along the line 6-6 in FIG. 5.

FIG. 7 is a perspective view of a security gate for interior installation.

FIG. 8 is a cross sectional view along the line 8-8 in FIG. 7.

FIG. 9 is a detailed front plan view of the security gate shown with reference to FIG. 7.

FIG. 10 is a cross sectional view along the line 10-10 in FIG. 9.

FIG. 11 is a front plan view showing the locking assembly for the security gate shown with reference to FIG. 7.

FIG. 12 is a cross sectional view of the locking assembly shown with reference to FIG. 11 along the line 12-12.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

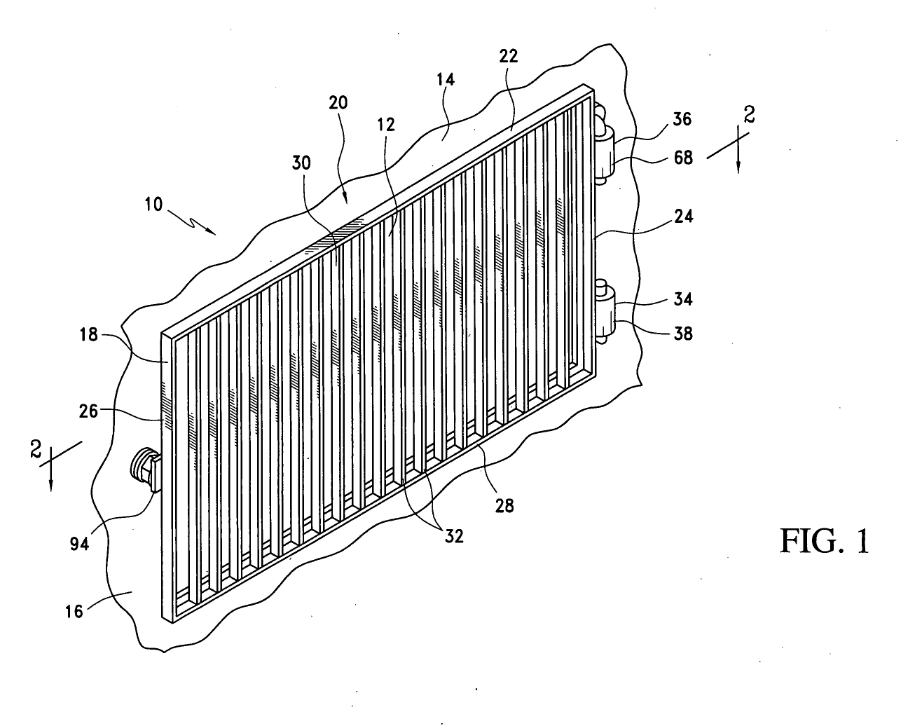

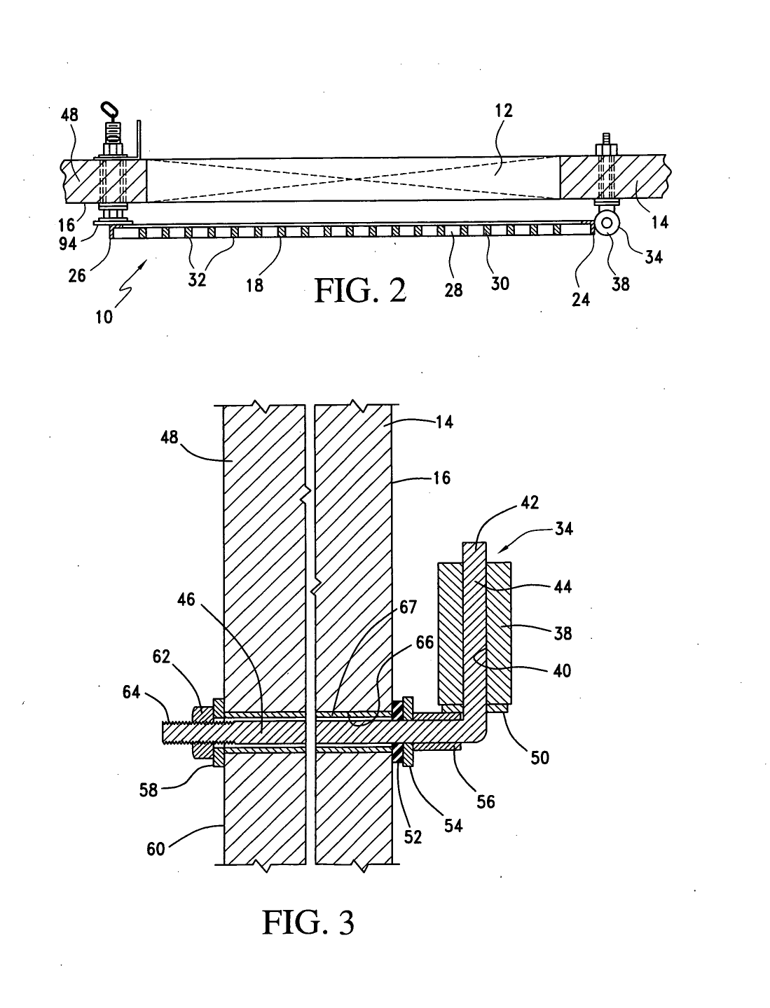

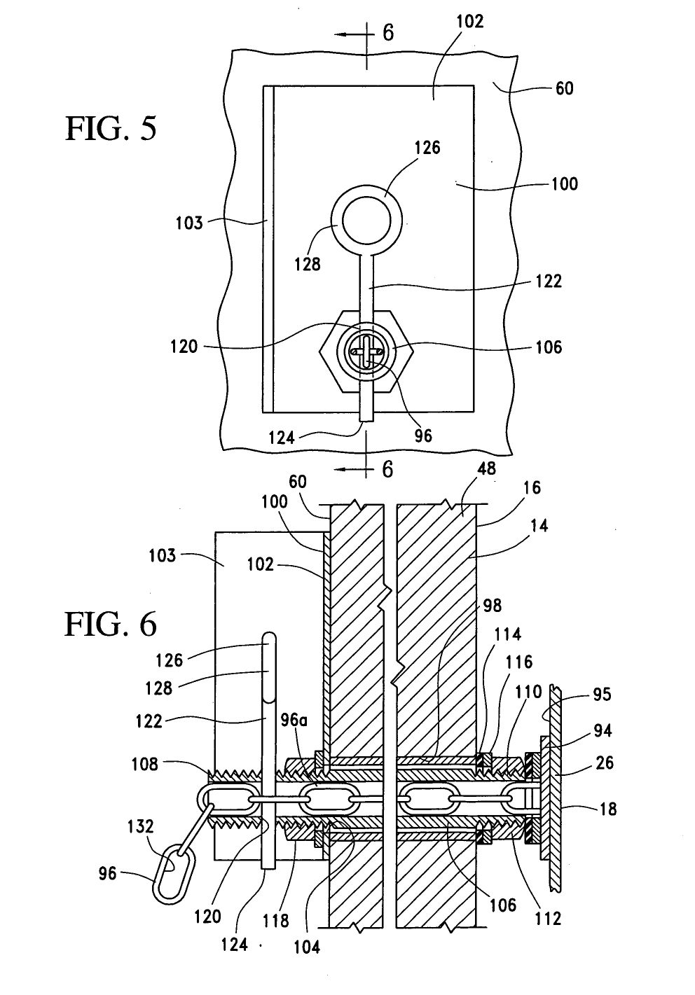

In accordance with the present invention, and with reference to FIGS. 1 to 6, a security gate 10 is disclosed for preventing passage through a window 12, or other passageway, formed in a building structure 14. The security gate 10 allows for selective opening and closing thereof, without diminishing the security gate's ability to prevent undesired passage through the window 12. Although the present security gate is disclosed herein as being positioned adjacent a window, those skilled in the art will appreciate the security gate may be positioned to prevent access through a variety of different passageways, such as a door, without departing from the spirit of the present invention.

As shown with reference to the embodiment disclosed in FIGS. 1 to 6, a security gate 10 for positioning on the exterior side, in particular, on the exterior wall 16 of a building structure 14 is disclosed. The security gate 10 includes a grate structure 18 shaped and dimensioned to fit over and cover the window 12 adjacent to which it is positioned. In fact, and as will be appreciated based upon the following disclosure, the grate structure 18 is slightly larger than the opening of the window 12, allowing for secure attachment of the grate structure 18 to the building structure 14 surrounding the window 12.

The grate structure 18 is composed of a frame 20 including a top frame member 22, a first side frame member 24, a second side frame member 26, and a bottom frame member 28. The top frame member 22, first side frame member 24, second side frame member 26, and bottom frame member 28 are connected to form a rectangular or square structure shaped and dimensioned to fully cover the window 12 in front of which it is positioned upon installation. While a square or rectangular shape is disclosed in accordance with a preferred embodiment of the present invention, those skilled in the art will appreciate passageways come in a variety of shapes and sizes and the gate structure of the present invention may be readily adapted to accommodate the various shapes and sizes. In addition, and in accordance with a preferred embodiment of the present invention, the grate structure, as well as other components (unless otherwise specified) of the security gate, are preferably made of steel although other functionally equivalent materials may be used without departing from the spirit of the present invention.

A grate assembly 30 is positioned within the internal space defined by the frame 20. The grate assembly 30 is shaped and dimensioned to prevent one from passing an arm or instrument therethrough in an attempt to open the security gate 10. With this in mind, and in accordance with a preferred embodiment of the present invention, the various bars 32 making up the grate assembly 30 are spaced no more than 1.5 inches from each other. The grate structure 18 is mounted to the building structure 14 surrounding the window 12 for pivotal motion relative thereto. In particular, the first side frame member 24 is provided with a first hinge assembly 34 and a second hinge assembly 36. Although a pair of hinge assemblies are disclosed in accordance with a preferred embodiment, it is contemplated a single hinge assembly or more hinge assemblies may be employed within the spirit of the present invention.

Referring to FIGS. 1, 2 and 3, the first hinge assembly 34 includes a first pipe sleeve 38 rigidly secured to the lower portion of the first side frame member 24. The first pipe sleeve 38 includes a central aperture 40 shaped and dimensioned to receive a first hinge bolt 42 in a manner allowing the first pipe sleeve 38, and ultimately the grate structure 18, to rotate relative thereto.

The first hinge bolt 42 is substantially L-shaped and includes a first leg 44 shaped and dimensioned for positioning within the first pipe sleeve 38 and a second leg 46 shaped and dimensioned for passage through the wall 48 of the building structure 14 for securely mounting the first hinge bolt 42, and ultimately the entire security gate 10, thereto. A metal washer 50 is positioned along the first leg 44 adjacent the juncture of the first leg 44 and the second leg 46 for supporting the base, or first end, of the first pipe sleeve 38. The second leg 46 is provided with the following mounting components along the exterior wall 16 of the building structure 14: a neoprene gasket seal 52 directly adjacent the exterior wall 16 of the building structure 14, a metal washer 54 directly adjacent the neoprene gasket seal 52 and a metal bushing 56 for shimming directly adjacent the metal washer 54. Along the interior wall 60 of the building structure 14, the first hinge bolt 42 is provided with a metal washer 58 directly adjacent the interior wall 60 of the building structure 14 and a nut 62 secured to the threaded free end 64 of the second leg 46 of the first hinge bolt 42 for securing the entire first hinge bolt 42 in position along the wall 48. In addition, the aperture 66 formed within the building structure 14 for the passage of the second leg 46 of the first hinge bolt 42 is lined with a metal sleeve 67. The nut 62 is coupled with the threaded free end 64 of the second leg 46 of the first hinge bolt 42 to ensure the first hinge bolt 42 is rigidly secured to the building structure 14.

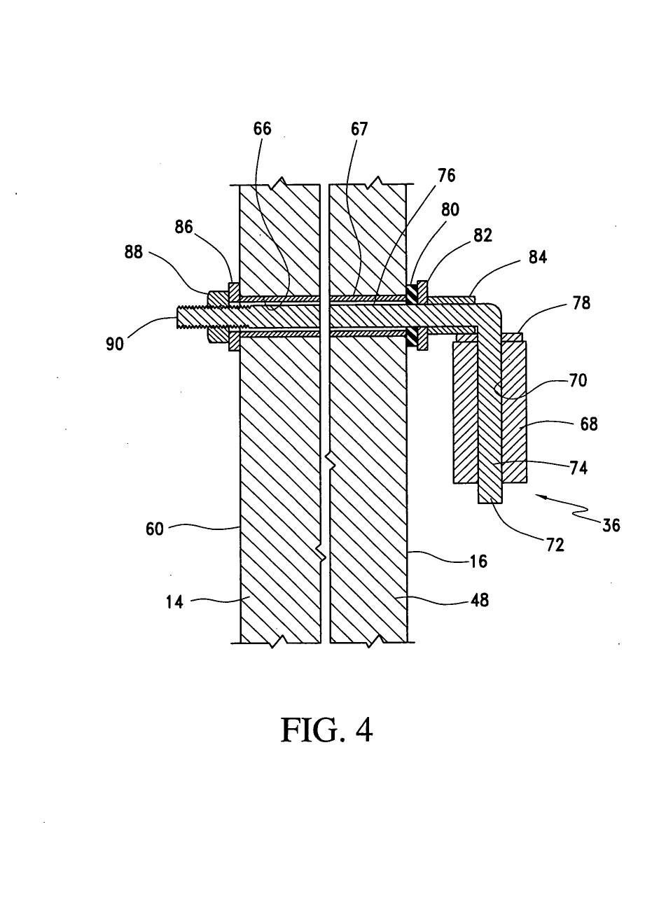

The second hinge assembly 36 is substantially a mirror image of the first hinge assembly 34 and, with reference to FIGS. 1 and 4, is secured adjacent to an upper edge of the first side frame member 24 of the frame 20. More particularly, the second hinge assembly 36 includes a second pipe sleeve 68 rigidly secured to the upper portion of the first side frame member 24. The second pipe sleeve 68 includes a central aperture 70 shaped and dimensioned to receive a second hinge bolt 72 in a manner allowing the second pipe sleeve 68, and ultimately the grate structure 18, to rotate relative thereto.

The second hinge bolt 72 is substantially L-shaped and includes a first leg 74 shaped and dimensioned for positioning within the second pipe sleeve 68 and a second leg 76 shaped and dimensioned for passage through the wall 48 of the building structure 14 for securely mounting the second hinge bolt 72, and ultimately the entire security gate 10, thereto. A metal washer 78 is positioned along the first leg 74 adjacent the juncture of the first leg 74 and the second leg 76 for shimming the top, or first end, of the second pipe sleeve 68. The second leg 76 is provided with the following mounting components along the exterior of the building structure 14: a neoprene gasket seal 80 directly adjacent the exterior wall 16 of the building structure 14, a metal washer 82 directly adjacent the neoprene gasket seal 80 and a metal bushing 84 for shimming directly adjacent the metal washer 82. Along the interior wall 60 of the building structure 14, the second leg 76 of the second hinge bolt 72 is provided with a metal washer 86 directly adjacent the interior wall 60 of the building structure 14 and a nut 88 secured to the threaded free end 90 of the second leg 76 of the second hinge bolt 72 for securing the entire second hinge bolt 72 in position along the wall 48. In addition, the aperture 66 within the building structure 14 is lined with a metal sleeve 67. The nut 88 is coupled with the threaded free end 90 of the second leg 76 of the second hinge bolt 72 to ensure the second hinge bolt 72 is rigidly secured to the building structure 14.

The hinge structure employed in accordance with the present invention provides for secure mounting of the grate structure 18. The hinge structure substantially prevents an intruder from accessing the mounting structure for the hinge by positioning the securing nuts 62, 88 along the interior wall 60 of the building structure 14, and ensuring there is no vertical play in the grate structure 18 as it is mounted between, and supported by, the first hinge bolt 42 and the second hinge bolt 72.

Referring to FIGS. 1, 2, 5 and 6, the second side frame member 26 is provided with a plate 94 welded to a rear surface 95 thereof such that it faces the exterior wall 16 of the building structure 14 when the security gate 10 is properly positioned for preventing access to the window 12. The plate 94 includes a steel chain 96 welded to plate 94 and extending therefrom. In accordance with a preferred embodiment, the steel chain 96 is composed of a plurality of links 96a connected to form the chain 96. The links 96a, and ultimately the chain 96, include a plurality of longitudinally spaced apertures 132 and is of a length and width sufficient to pass through the building structure 14 in the area adjacent to the window 12 with the security gate 10 positioned over the window 12. In order to permit the passage of the steel chain 96 through the building structure 14, the building structure 14 is provided with a metal sleeve lined bore 98 substantially aligned with the plate 94 in a manner allowing ready passage of the chain 96 through the building structure 14 and into the interior of the building structure 14.

A tamper shield bracket 100 is secured along the interior wall 60 of the building structure 14 in alignment with the sleeve lined bore 98. More particularly, the tamper shield bracket 100 includes a planar plate 102 shaped and dimensioned for attachment to the interior wall 60 of the building structure 14. The tamper shield bracket 100 also includes an aperture 104 which is aligned with the sleeve lined bore 98 for passage of the steel chain 96 therethrough. The tamper shield bracket 100 further includes a tamper protection flange 103 that extends from an edge of the plate 102 at a 90° angle along the side of the plate 102 closest to the window 12. In this way, the tamper protection flange 103 substantially prevents direct access to the locking pin 122 by one reaching through the window 12 and, as such, prevents tampering with the present security gate 10.

The tamper shield bracket 100 is securely mounted upon the wall 48 by a cylindrical compression sleeve 106. The compression sleeve 106 is secured at its first end 108 to the plate 102 in alignment with the sleeve lined bore 98. At its second end 110 the compression sleeve 106 is drawn toward the interior wall 60 maintaining the compression sleeve 106, and ultimately the tamper shield bracket 100 in position. More particularly, an apertured locknut 112 is threadingly secured to the second end 110 of the compression sleeve 106 with the second end 110 of the compression sleeve 106 extending from the exterior of the building structure 14. A neoprene bushing 116 and a steel bushing 114 are positioned between the locknut 112 and the exterior wall 16 of the building structure 14. The locknut 112 is sized to prevent inward movement (that is, toward the interior wall 60 of the building structure 14) of the cylindrical compression sleeve 106. The first end 108 of the cylindrical compression sleeve 106 extends into the interior of the building structure 14 and through the aperture 104 formed within the plate 102. A nut 118 is screwed to the threaded first end 108 of the cylindrical compression sleeve 106 pulling the plate 102 against the interior wall 60 and using the compression of the nut 118 and locknut 112 along the respectively interior wall 60 and exterior wall 16 to hold the tamper shield bracket 100 in position. Access to the locknut 112 or chain 96 for tampering is prevented when steel plate 94 closes against locknut 112, that is, when security gate 10 is in the closed position, to thereby substantially limit access thereto.

The first end 108 of the cylindrical compression sleeve 106 is further provided with a transversely extending aperture 120 shaped and dimensioned for receiving a locking pin 122. The locking pin 122 includes a first end 124 shaped and dimensioned for passing through the transversely extending aperture 120 of the cylindrical compression sleeve 106 for engaging the chain 96 as will be discussed below in greater detail. The locking pin 122 also includes a second end 126 with a handle 128 for inserting or retracting the locking pin 122.

In accordance with a preferred embodiment, the grate structure 18 is pivotally secured to the building structure 14 along the first side frame member 24 of the grate structure 18 for permitting movement of the grate structure 18. In particular, the grate structure is mounted to permit movement of the second side frame member 26 between a closed position in which the second side frame member 26 is positioned directly adjacent the exterior wall 16 of the building structure 14 with the grate structure 18 covering the window 12 and an open position in which the second side frame member 26 is positioned remotely from the exterior wall 16 of the building structure 14 such that the grate structure 18 no longer covers the window 12 and one may readily pass through the passageway defined by the window 12.

The security gate 10 is held in its closed orientation by way of the chain 96 extending from the second side frame member 26. The chain 96 is pulled to extend through the wall 48 of the building structure 14, in particular, through the compression sleeve 106 and the metal sleeve lined bore 98, with the free end 130 of the chain 96 extending along the interior of the building structure 14. With the grate structure 18 pulled firmly against the exterior wall 16 of the building structure 14, the locking pin 122 is passed through the transversely extending aperture 120 in the compression sleeve 106 and simultaneously through an aperture 132 of the chain 96. In this way, the chain 96 and locking pin 122 prevent movement of the grate structure 18 until such a time that the locking pin 122 is removed and the grate structure 18 is free to pivot to its open configuration.

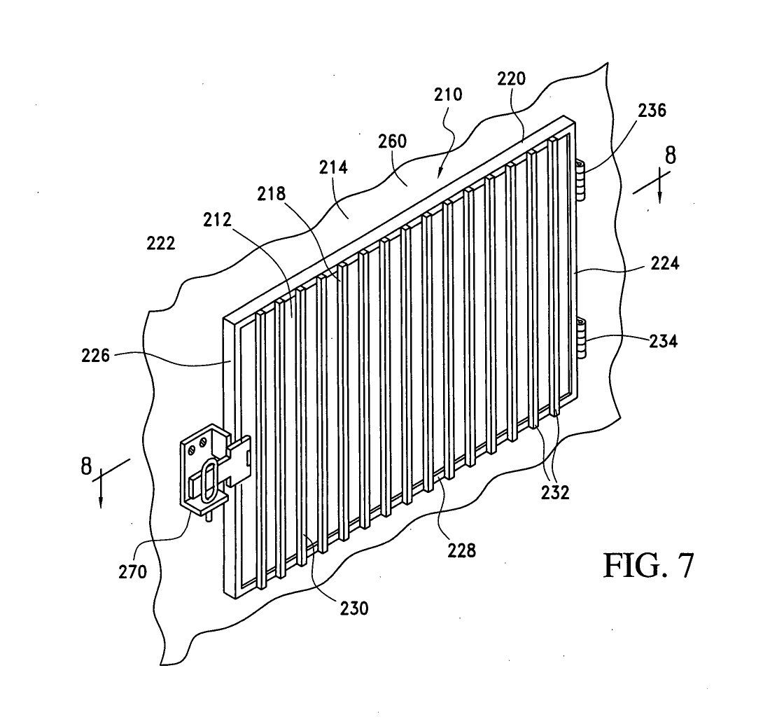

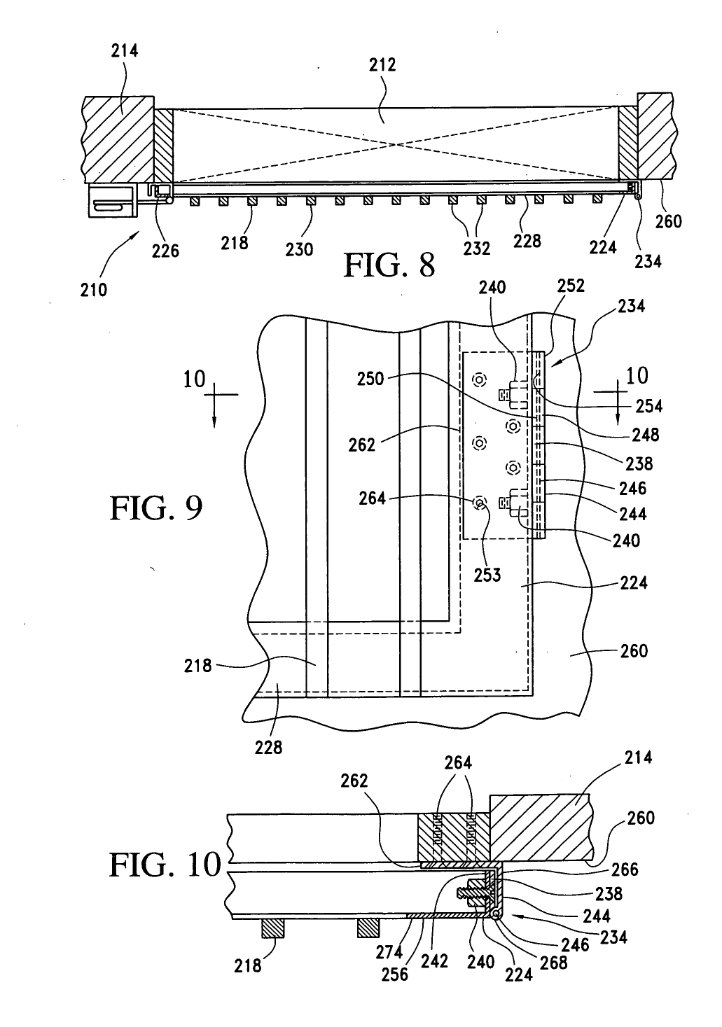

As shown with reference to the embodiment disclosed in FIGS. 7 through 12, an alternate embodiment of a security gate 210 for positioning along an interior wall 260 of a building structure 214 is disclosed. As with the prior embodiment, the security gate 210 includes a grate structure 218 shaped and dimensioned to fit over and cover the window 212 adjacent to which it is positioned. In fact, and as will be appreciated based upon the following disclosure, the grate structure 218 is slightly larger than the opening of the window 212, allowing for secure attachment of the grate structure 218 to the building structure 214, for example, the window jamb, surrounding the window 212.

The grate structure 218 is composed of a frame 220 including a top frame member 222, a first side frame member 224, a second side frame member 226, and a bottom frame member 228. The top frame member 222, first side frame member 224, second side frame member 226, and bottom frame member 228 are connected to form a rectangular or square structure shaped and dimensioned to fully cover the window 212 in front of which it is positioned upon installation. While a square or rectangular shape is disclosed in accordance with a preferred embodiment of the present invention, those skilled in the art will appreciate passageways come in a variety of shapes and sizes and the gate structure of the present invention may be readily adapted to accommodate the various shapes and sizes.

A grate assembly 230 is positioned within the internal space defined by the frame 220. The grate assembly 230 is shaped and dimensioned to prevent one from passing an arm or instrument thetethrough in an attempt to open the security gate 210. With this in mind, and in accordance with a preferred embodiment of the present invention, the various bars 232 making up the grate assembly 230 are spaced no more than 15 inches from each other.

The grate structure 218 is mounted to the building structure 214, in particular, the window jamb, surrounding the window 212 for pivotal motion relative thereto. In particular, the first side frame member 224 is provided with a first hinge assembly 234 and a second hinge assembly 236. Although a pair of hinge assemblies are disclosed in accordance with a preferred embodiment, it is contemplated a single hinge assembly or more hinge assemblies may be employed within the spirit of the present invention.

Referring to FIGS. 7, 8, 9 and 10, the first hinge assembly 234 includes a first hinge plate 238 rigidly secured by a pair of nut and bolt assemblies 240 to the lower portion of the first side frame member 224 for positioning along a lateral side 242 of the grate structure 218. The first hinge assembly 234 also includes a second hinge plate 244 pivotally coupled to the first hinge plate 238 via a pivot pin 246. The first hinge plate 238 includes a series of outwardly extending flanges 248 defining a central aperture 250 and the second hinge plate 244 includes a series of outwardly extending flanges 252 defining a central aperture 254, wherein the outwardly extending flanges 248 of the first hinge plate 238 are shaped and dimensioned to mate with the outwardly extending flanges 252 of the second hinge plate 244 with the respective central apertures 250, 254 of the first and second hinge plates 238, 244 aligned for the passage, and containment of the pivot pin 246 therethrough.

As briefly mentioned above, the first hinge plate 238 is shaped and dimensioned for flush mounting along the lateral side wall 242 of the first side frame member 224 with the series of outwardly extending flanges 248 extending just beyond the front surface 256 of the first side frame member 224. The second hinge plate 244 includes a first leg 262 including the series of apertures 253 shaped and dimensioned for receiving screws 264 used in mounting the first hinge assembly 234 to the building structure 214 (for example, to the window jamb). The second hinge plate 244 includes a second leg 266 oriented substantially perpendicular to the first leg 262. The series of outwardly extending flanges 248 are mounted at the free end 268 of the second leg 266 and turn slightly inwardly so as to mate with the outwardly extending flanges 248 of the first hinge plate 238 in a manner allowing for a flush mating of the first and second hinge plates 238, 244 when the grate structure 218 is in its closed orientation.

The second hinge assembly 236 is substantially identical to the first hinge assembly 234, other than being positioned adjacent to an upper edge of the first side frame member 224 of the frame 220. As such, the preceding disclosure encompasses the construction of the second hinge assembly 236.

As with the prior embodiment, and in accordance with a preferred embodiment, the security gate 210 is pivotally secured to the building structure 214 along the first side frame member 224 of the grate structure 218 for permitting movement of the grate structure 218, in particular, the second side frame member 226 between a closed position in which the second side frame member 226 is positioned directly adjacent the interior wall 260 of the building structure 214 with the grate structure 218 covering the window 212 and an open position in which the second side frame member 226 is positioned remotely from the interior wall 260 of the building structure 214 such that the grate structure 218 no longer covers the window 212 and one may readily pass through the passageway defined by the window 212.

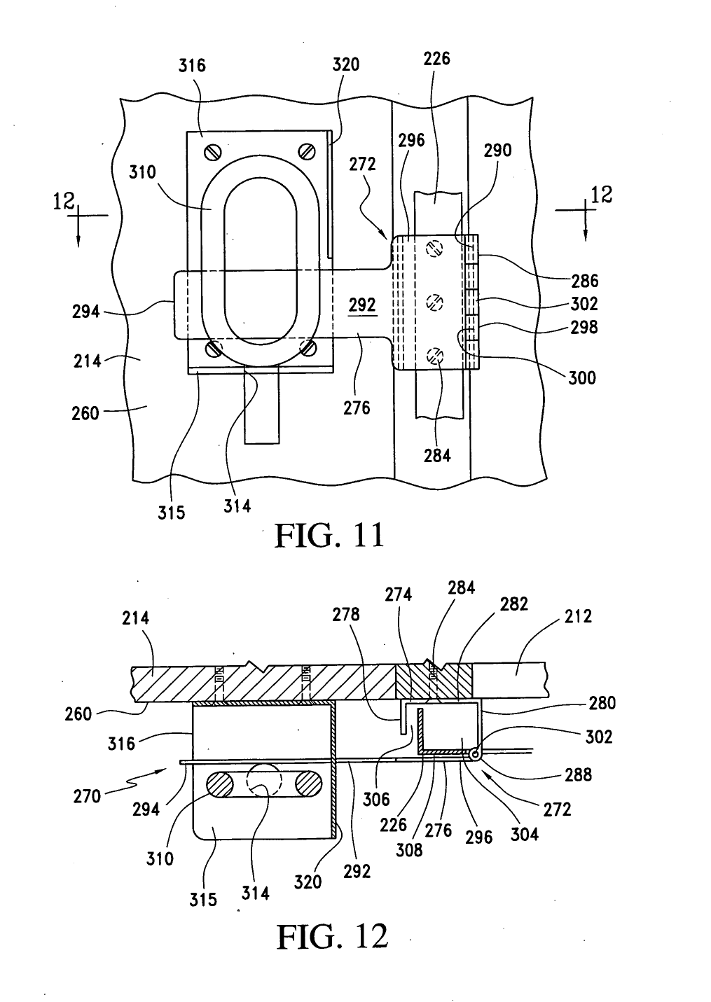

Referring to FIGS. 11 and 12, a locking assembly 270 is secured along the interior wall 260 of the building structure 214 for selective engagement with the second side frame member 226 to control opening and closing of the grate structure 218. More particularly, the locking assembly 270 includes a locking hinge 272 composed of a first locking hinge member 274 and a second locking hinge member 276 shaped and dimensioned to wrap around the second side frame member 226 to selectively prevent movement of the grate structure 218. The first locking hinge member 274 is substantially U-shaped and includes a first leg 278 and second leg 280 with a connecting plate member 282 extending therebetween. In practice, the connecting plate member 282 is mounted to the interior wall 260 of the building structure 214, for example, along the window jamb, by a series of screws 284. The connecting plate member 282 is mounted such that the first leg 278 is positioned away from the window 212, while the second leg 280 is mounted adjacent the window 212. As will be appreciated based upon the following disclosure, the first leg 278 is shorter than the second leg 280 and the first leg 278 functions as a frame stop for controlling the positioning of the grate structure 218 relative to the window jamb when the security gate 210 is in its closed orientation.

As to the second leg 280, a series of outwardly extending flanges 286 are provided at its free end 288. The outwardly extending flanges 286 of the second leg 280 define a central aperture 290. The second locking hinge member 276 is a substantially planar plate 292 with a first end 294 and a second end 296. A series of outwardly extending flanges 298 defining a central aperture 300 are formed at the second end 296 of the second locking hinge member 276. The outwardly extending flanges 286 of the first locking hinge member 274 are shaped and dimensioned to mate with the outwardly extending flanges 298 of the second locking hinge member 276 with the respective central apertures 290, 300 of the first and second locking hinge members 274, 276 aligned for the passage of the pivot pin 302 therethrough.

As a result, the first and second locking hinge members 274, 276 define a cavity 304 into which the second side frame member 226 is positioned for locking the grate structure 218 in a closed orientation. In particular, the second side frame member 226 is shaped and dimensioned to fit within the U-shaped space 306 defined by the first locking hinge member 274. With the second side frame member 226 positioned within the space defined by the first locking hinge member 274, the second locking hinge member 276 is allowed to wrap about the outer surface 308 of the second side frame member 226 creating a cavity 304 in which the second side frame member 226 is locked until such a time that the second locking hinge member 276 is pivoted away from its position in front of the second side frame member 226 and the grate structure 218 is free to pivot away from the locking assembly 270. The cavity 304 also provides protection from manipulation of, and tampering with, the screws 284 to the building structure 214. The second locking hinge member 276 is maintained in position by a locking pin 310 shaped and dimensioned to engage an aperture 314 in a flange 315 of a locking plate 316 mounted to the interior wall 260 in a position adjacent the first locking hinge member 274 with the first end 294 of the second locking hinge member 276 held between the locking pin 310 and the locking plate 316. As such, the locking pin 310 is passed through the aperture 314 of the second locking hinge member 276 and the aperture 314 of the locking plate 316 with the second locking hinge member 276 positioned between the locking pin 310 and the locking plate 316. When in this position, the second locking hinge member 276 is unable to move and the second side frame member 226 is maintained within the cavity 304 defined by the first and second locking hinge members 274, 276. When it is desired to open the grate structure 218 for access to the window 212, the locking pin 310 is removed, the second locking hinge member 276 is rotated away from its position adjacent the second side frame member 226 and the grate structure 218 is free to rotate away from its position covering the window 212. Access from the building exterior to the locking pin 310 is prevented by the provision of an outwardly extending tamper protection flange 320 along the edge of the locking plate 316 closest to the window 212. It should be noted that when the gate assembly 230 is in the closed position all screws are inaccessible and cannot be removed by tampering.

It is preferred that the primary components of the present security gate be manufactured from high quality steel in view of its durability and cost. However, a variety of high strength materials are known in the art, and a balance of cost and security would ultimately be utilized in determining the specific materials used in the implementation of the present invention.

While the preferred embodiments have been shown and described, it will be understood that there is no intent to limit the invention by such disclosure, but rather, is intended to cover all modifications and alternate constructions falling within the spirit and scope of the invention.

1. An exterior security gate for preventing passage through a passageway in a building structure, comprising:
a grate structure shaped and dimensioned to fit over and cover the passageway, the grate structure includes a first side frame member and a second side frame member;
a first hinge assembly secured to the first side frame member for pivotally mounting the grate structure to an exterior wall of a building structure;
a chain with a plurality of apertures, the chain is secured to and extends from the second side frame member, the chain is of a length sufficient to pass through a bore formed in the building structure in the area proximate to the passageway with the grate structure positioned over the passageway; and
a tamper shield bracket secured along an interior wall of the building structure in alignment with the bore, the tamper shield bracket includes a locking pin selectively positioned within an aperture of the chain to securely lock the grate structure in a closed orientation.

2. The exterior security gate according to claim 1, wherein the tamper shield bracket includes an aperture aligned with the aperture passing through the wall of the building structure for passage of the chain therethrough.

3. The exterior security gate according to claim 1, wherein the tamper shield bracket includes a tamper protection flange extending from an edge at a 90° angle along the side of the tamper shield bracket closest to the passageway.

4. The exterior security gate according to claim 3, wherein the tamper shield bracket includes a compression sleeve securely mounting it upon the wall of the building structure.

5. The exterior security gate according to claim 4, wherein the aperture of the tamper shield bracket through which the locking pin passes is formed in the compression sleeve.

6. The exterior security gate according to claim 1, wherein the grate structure includes a grate assembly including a plurality of bars that are spaced no more than 1.5 inches from each other.

7. The exterior security gate according to claim 1, wherein the first hinge assembly includes a first pipe sleeve including a central aperture shaped and dimensioned to receive a first hinge bolt secured to the exterior wall of the building structure.

8. The exterior security gate according to claim 7, wherein the first hinge bolt is substantially L-shaped and includes a first leg shaped and dimensioned for positioning within the first pipe sleeve and a second leg shaped and dimensioned for passage through the wall of the building structure for securely mounting the first hinge bolt, and ultimately the entire security gate, thereto.

9. The exterior security gate according to claim 8, wherein a nut is secured to a threaded free end of the second leg of the first hinge bolt for securing the first hinge bolt in position along the wall.

10. The exterior security gate according to claim 7, further including a second hinge assembly, the second hinge assembly includes a second pipe sleeve including a central aperture shaped and dimensioned to receive a second hinge bolt secured to the exterior wall of the building structure.

11. The exterior security gate according to claim 10, wherein the second hinge bolt is substantially L-shaped and includes a first leg shaped and dimensioned for positioning within the second pipe sleeve and a second leg shaped and dimensioned for passage through the wall of the building structure for securely mounting the second hinge bolt, and ultimately the entire security gate, thereto.

12. The exterior security gate according to claim 11, wherein a nut is secured to a threaded free end of the second leg of the second hinge bolt for securing the first hinge bolt in position along the wall.

13. The exterior security gate according to claim 1, wherein the second side frame member includes a plate which couples the chain to the second side frame member.

14. The exterior security gate according to claim 1, wherein the bore passing through the building structure is a metal sleeve lined bore.

15. An interior security gate for preventing passage through a passageway in a building structure, comprising:
a grate structure shaped and dimensioned to fit over and cover the passageway, the grate structure includes a first side frame member and a second side frame member;
a first hinge assembly secured to the first side frame member for pivotally mounting the grate structure to an interior wall of a building structure; and
a locking assembly secured along an interior wall surface of the building structure for selective engagement with the second side frame member to control opening and closing of the grate structure, the locking assembly includes a locking hinge composed of a first locking hinge member and a second locking hinge member shaped and dimensioned to wrap around the second side frame member to selectively prevent movement of the grate structure.

16. The interior security gate according to claim 15, wherein the first locking hinge member is substantially U-shaped and includes a first leg and a second leg with a connecting plate member extending therebetween.

17. The interior security gate according to claim 15, where the first locking hinge member and the second locking hinge member define a cavity into which the second side frame member is positioned for locking the grate structure in a closed orientation.

18. The interior security gate according to claim 15, wherein a locking pin maintains the second locking hinge member in position.
